(19) United States
(12) Patent Application Publication
(10) Pub. No.: US 2015/0074057 A1
(43) Pub. Date: Mar. 12, 2015

(54) METHOD AND SYSTEM FOR SELECTIVE PRESERVATION OF MATERIALS RELATED TO DISCOVERY

(71) Applicant: OpenPeak Inc., Boca Raton, FL (US)

(72) Inventors: Larry G. Brown, Royal Palm Beach, FL (US); Carsten Michael Dietz, Boynton Beach, FL (US)

(21) Appl. No.: 14/335,180

(22) Filed: Jul. 18, 2014

Related U.S. Application Data
(60) Provisional application No. 61/847,719, filed on Jul. 18, 2013.

(51) Int. Cl. G06F 11/14; H04L 29/06

(52) U.S. Cl. CPC G06F 11/1451; G06F 11/1412; H04L 63/308
USPC 707/644

(57) ABSTRACT

A method and system for selective preservation of materials related to discovery is described herein. The method includes the step of receiving at a computing device a preservation notification based on a litigation event against an enterprise that warrants preservation of related documents. In response to the receipt of the preservation notification, the computing device can be placed in a preservation mode. As part of the preservation mode, materials from at least enterprise materials on the computing device that are to be preserved for discovery can be identified. In addition, the computing device may be a personal computing device of an associate of the enterprise. The method can also include the step of automatically creating back-up copies of the identified materials to comply with preservation requirements related to the litigation event.

### CROSS-REFERENCE TO RELATED APPLICATIONS

This patent application claims priority to U.S. Patent Application No. 61/847,719, filed on Jul. 18, 2013, which is incorporated herein by reference in its entirety.

### FIELD OF TECHNOLOGY

The present description relates to systems and methods for the preservation of materials and more particularly, for the preservation of materials related to litigation discovery.

### BACKGROUND

Many companies and organizations now permit their employees or associates to conduct company business on their personal mobile devices. For example, an enterprise may allow an individual to install an email application on that person's mobile devices for purposes of managing the enterprise's email on that device. Commonly referred to as a bring-your-own-device (BYOD) arrangement, this policy has added convenience to persons associated with the accommodating enterprises and has increased productivity.

Eventually, an organization that has enabled a BYOD policy may find itself faced with litigation. Once litigation or even the threat of it arises, many jurisdictions require the parties subject to the dispute to preserve evidence to comply with discovery procedures. If, for example, an employee of a company that has been sued has emails or other documents on the employee's personal mobile device that are related to the suit, the employee may be required to take steps to preserve such material. In drastic cases, the affected company may be required to confiscate the personal mobile device of the employee to comply with certain discovery requests or orders. Of course, such a circumstance would lead to difficulties in conducting conventional business practices and may lead companies away from instituting BYOD policies.

### SUMMARY

A method for selective preservation of materials related to discovery is described herein. The method can include the step of receiving—at a computing device—a preservation notification based on a litigation event against an enterprise that warrants preservation of related documents. In response to the receipt of the preservation notification, the computing device can be placed in a preservation mode. As part of the preservation mode, materials from at least enterprise materials on the computing device that are to be preserved for discovery can be identified. The computing device may be a personal computing device of an associate of the enterprise. In addition, back-up copies of the identified materials can be automatically created to comply with preservation requirements related to the litigation event.

The method can also include the steps of detecting the creation or receipt of new enterprise materials on the computing device and determining whether the new enterprise materials on the computing device should be preserved for discovery. Back-up copies of the new enterprise materials can be selectively and automatically created based on the determination of whether the new enterprise materials should be preserved for discovery.

In one arrangement, automatically creating back-up copies of the identified materials can include transferring the back-up copies to a memory that is remote from the computing device. As an example, the enterprise materials can be associated with a workspace container that is part of the computing device. As another example, the enterprise materials may only by associated with secure applications that are installed on the computing device.

The method can also include the steps of preventing the deletion of the identified materials as part of the preservation mode and encrypting at least a portion of the back-up copies of the identified materials. This encryption may occur prior to, during or following the transfer of the back-up copies. In addition, identifying materials from at least enterprise materials on the computing device may include analyzing electronic documents for predetermined key words or phrases.

Another method for selective preservation of materials related to discovery is described herein. In this method, a preservation notification can be received at a computing device based on a litigation event against an enterprise that warrants preservation of related documents. The computing device can be a managed device associated with the enterprise. In response to the receipt of the preservation notification, the computing device in a preservation mode. As part of the preservation mode, materials may be identified from only enterprise materials on the computing device for preservation for discovery, and back-up copies of the identified materials can be automatically created to comply with preservation requirements related to the litigation event.

As an example, the enterprise materials may be limited to materials associated with secure applications that have been installed on the computing device. In one particular example, at least one of the secure applications can be a secure email application. The method can also include the steps of transferring the back-up copies to a remote storage and as part of this transfer, encrypting the back-up copies. In one embodiment, the preservation notification may identify which materials are required to be preserved, which applications or programs installed on the computing device are affected, when the preservation mode should be entered, the identity of the opposing party in the litigation event or the destination for the back-up copies.

A computing device that is associated with an enterprise is also described herein. The device can include an interface that can be configured to receive a preservation notification based on a litigation event against the enterprise. The litigation event may warrant preservation of related documents, and the computing device can be a managed device with respect to the enterprise. The device may also include a preservation engine. The preservation engine can be configured to—in response to the preservation notification—place the computing device in a preservation mode, while in the preservation mode, identify materials on the computing device that are to be preserved for discovery and automatically create back-up copies of the identified materials to comply with preservation requirements related to the litigation event.

The computing device can also include an encryption engine that can be configured to encrypt the automatically-created back-up copies. In one arrangement, the preservation engine can be further configured to identify the materials to be preserved by initiating an analysis of electronic documents for key words or phrases. In another arrangement, the interface can be further configured to transfer the back-up copies to a remote storage location. As an option, one or more parties other than the enterprise may be given access to the remote storage location. In another example, the identified materials may be limited to materials associated with secure applications that have been installed on the computing device, and at least one of the secure applications can be a secure email application. The preservation engine can be further configured to detect the presence of new enterprise materials on the computing device and selectively and automatically creating back-up copies of the new enterprise materials based on whether the new enterprise materials should be preserved for discovery.

Further features and advantages, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for selective preservation of materials related to discovery.

FIG. 2 illustrates an example of a computing device that may be part of the system of FIG. 1 and that may assist in the selective preservation of materials related to discovery.

FIG. 3 illustrates an example of a method for selective preservation of materials related to discovery.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are directly or indirectly connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more components that are configured to store instructions that are to be executed by a processing unit or some other component.

An “application” is defined as a program or programs that perform one or more particular tasks on a computing device. Examples of an application include programs that may present a user interface for interaction with a user or that may run in the background of an operating environment and that may not present a user interface while in the background. The term “secure application” is defined as an application that has been modified from its conventional form to restrict communication between the application and unauthorized programs or devices and restrict operation of the application based on policy or to alter, augment or add features associated with the operation of the application. A “non-secure application,” conversely, is defined as an application that has not been converted to a secure application. The term “operating system” is defined as a collection of software components that directs a computing device's operations, including controlling and scheduling the execution of other programs and managing storage, input/output and communication resources.

A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. An “interface” is defined as a component or a group of components that enable(s) a device to communicate with one or more different devices, whether through hard-wired connections, wireless connections or a combination of both. A “preservation engine” or “preservation unit” is a component or a group of components—through the utilization of any suitable combination of hardware and software—that is able to take steps to ensure the preservation of certain materials on a computing device that may be related to a litigation event.

The term “preservation notification” is defined as a notification that is intended to cause a computing device to take action to ensure the preservation of certain materials on a computing device that may be related to a litigation event. The term “litigation event” is defined as litigation that has commenced or pre-litigation actions that may cause a party to anticipate litigation. An “enterprise” is defined as a company, organization, firm, partnership or group that operates to carry out some purpose or function. A “document” is defined as any data, whether in electronic form or otherwise, that may be collected and preserved for possible later retrieval. The term “preservation mode” is defined as a mode in which a computing device may be placed and is characterized by actions that are intended to preserve documents for purposes of complying with discovery requests or orders. To the extent that any definitions in this description conflict with any definitions from any documents that have been incorporated by reference herein, the definitions in this description take precedence.

As explained earlier, many employees of enterprises use their personal mobile devices to conduct company business, such as through email or other message exchange. Unfortunately, if the enterprise is facing litigation or even the threat of it, it may be necessary to confiscate the employees' personal mobile devices to fully comply with discovery orders related to the litigation.

As a solution, a method and system for selective preservation of materials related to discovery is presented herein. The method includes the step of receiving at a computing device a preservation notification based on a litigation event against an enterprise that warrants preservation of related documents. In response to the receipt of the preservation notification, the computing device can be placed in a preservation mode. As part of the preservation mode, materials from at least enterprise materials on the computing device that are to be preserved for discovery can be identified. In addition, the computing device may be a personal computing device of an associate of the enterprise. The method can also include the step of automatically creating back-up copies of the identified materials to comply with preservation requirements related to the litigation event.

Thus, when litigation arises, steps can be automatically taken to preserve materials that may be subject to discovery. This process can minimize interruptions to the affected employees, while protecting the enterprise from accusations of failing to comply with discovery orders.

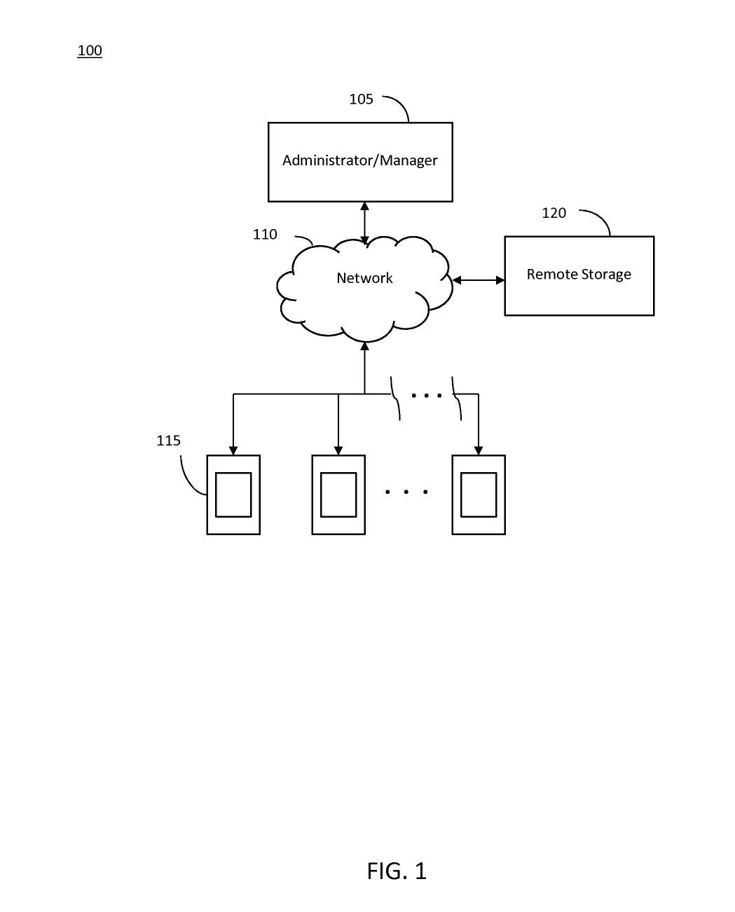

Referring to FIG. 1, a system 100 that can facilitate the principles described herein is shown. In one arrangement, the system 100 can include an administrator 105, a network 110, any number of computing devices 115 and remote storage 120. The administrator 105 can be any combination of components for managing, provisioning or maintaining any number of the computing devices 115. For example, the computing devices 115 may have clients installed on them that work with the administrator 105 to allow the administrator 105 to control settings or take actions on the computing devices 115. The network 110 may enable the computing devices 115 to communicate with one another and the administrator 105. Although only one entity is pictured here, the network 120 can be any suitable combination of networks and communication components to enable such communications, including local or wide-area and wired or wireless communications. The remote storage 120 can be any suitable form of persistent memory that can enable the computing devices 115 to transfer data to it for purposes of creating back-up copies of the data. The data that is transferred to and stored in the remote storage 120 may be encrypted, although the data may be unencrypted for storage, if desired.

In one example, the administrator 105 may be under the control or supervision of an enterprise or other organization, and associates of the enterprise may be the users (and owners) of the computing devices 115. The computing devices 115 may be mobile units that are at least partially used by the associates for business related to the enterprise. For example, the associates may use the computing devices 115 to exchange enterprise emails with other individuals involved with the enterprise. The enterprise may also manage the operation of the remote storage 120, including controlling access to the data stored therein. The remote storage 120, however, may be managed by some other entity that may or may not be under the control or supervision of the enterprise.

In a broad sense, the enterprise may become involved in litigation or at least may be faced with the possibility of being sued. Pursuant to most jurisdictions, the enterprise may be required to take action to preserve materials that may be related to the litigation. Here, the administrator 105 may signal one or more of the computing devices 115, and in response, the computing devices 115 can take steps to ensure compliance with any discovery obligations. For example, the computing devices 115 can identify materials that may be related to the litigation, and can transfer copies of these materials to the remote storage 120. Additional examples and description of this process will be presented below.

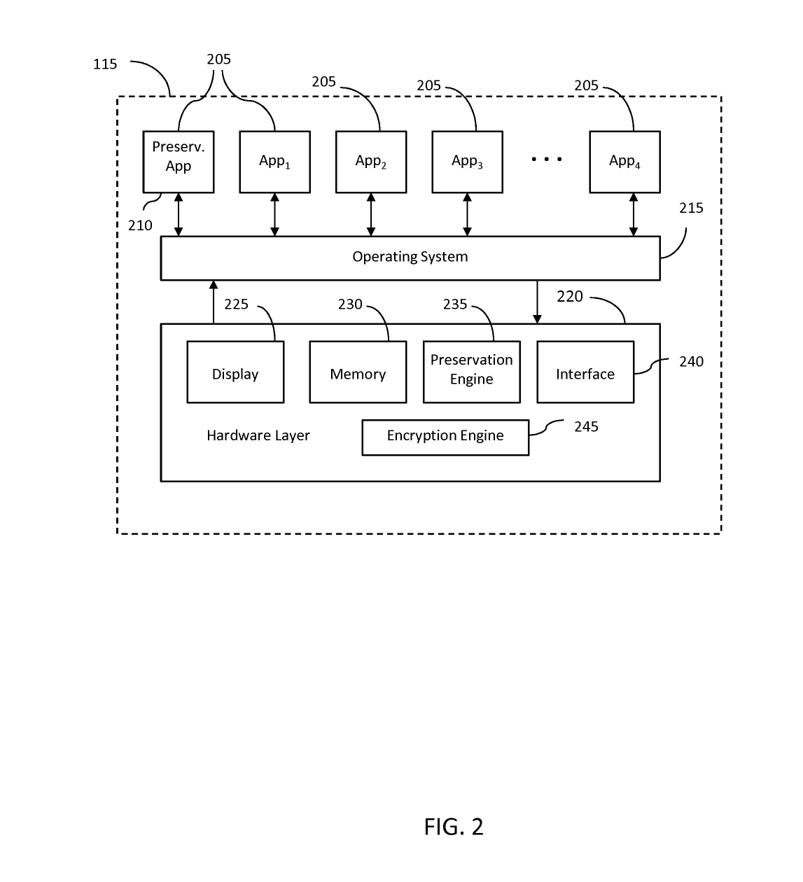

Referring to FIG. 2, an exemplary block diagram of a computing device 115 is shown. In one example, the computing device 115 can include multiple applications 205 for interaction with an associate. Some of these applications 205 may be capable of generating documents or other materials (electronic or otherwise) that are related to the business of the enterprise. For example, one of the applications 205 may be an email application, while another may be a word processing application. In one arrangement, one of the applications 205 may be a preservation application 210, which can be responsible for managing (or assisting in the management of) the process of preserving materials in accordance with the description herein.

The computing device 115 can include an operating system 215, which can facilitate the operation of each of the applications 205, and a hardware layer 220. The hardware layer 220 may include various hardware components, such as a display 225, memory (persistent, temporary or both) 230, a preservation engine 235, an interface 240 and an encryption engine 245. Of course, these components are merely exemplary in nature, as the hardware layer 220 may include virtually any type and number of hardware devices. In any event, the display 225 may serve as the primary user interface element for the computing device 115, and the memory 230, which can include any suitable amount and type of storage units (e.g., internal and removable) can store any suitable type of data related to the operation of the computing device 115. The preservation engine 235, as will be described in detail below, can work with the preservation application 210 to enable the preservation of discoverable materials. The interface 240, as an example, can permit local or wide area communications with various networks and other external components, including via both wired and wireless signals. Moreover, the encryption engine 245 can encrypt/decrypt data that may be sent to or retrieved from internal or external storage units, like the remote storage 120. Other abstraction layers and libraries, although not pictured here, may also form part of the computing device 115, particularly those that are involved in the operation of mobile devices.

In one arrangement, at least some of these applications 205 may be secure applications, which are conventional applications that have been modified to support the policies and protect the data of an enterprise or organization that has some association with the user of the computing device 115. For example, a secure application may be configured to encrypt data that it writes to storage or to block certain features based on a current location in which the computing device 115 is operating. As another example, through namespace enforcement and other techniques, non-secure applications may be restricted from exchanging data with or otherwise accessing the secure applications installed on the device 115. Additional information on this arrangement, including how secure applications may be created, can be found in U.S. Pat. No. 8,695,060, issued on Apr. 8, 2014, U.S. patent application Ser. No. 14/205,661, filed on Mar. 12, 2014 and U.S. patent application Ser. No. 14/205,686, filed on Mar. 12, 2014, each of which is incorporated by reference herein in its entirety.

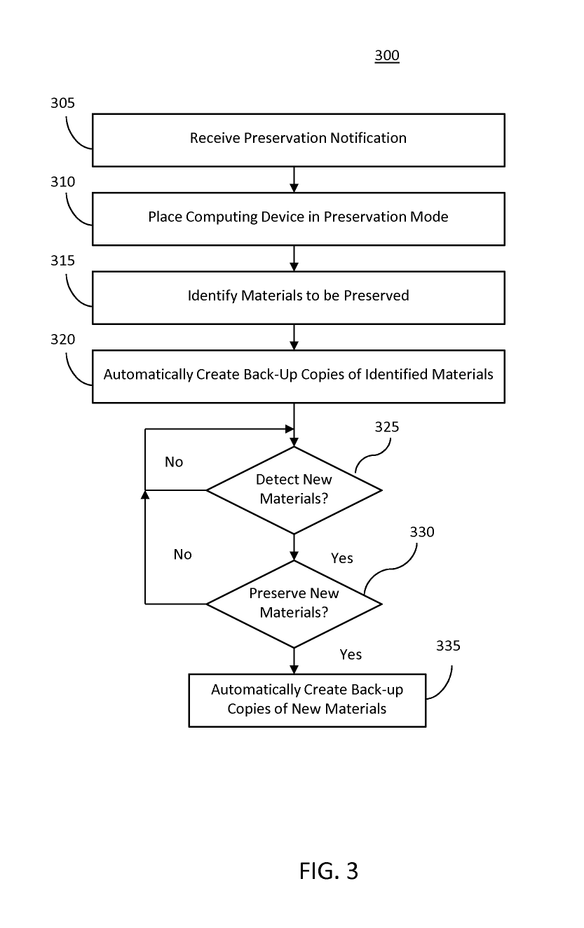

Referring to FIG. 3, an example of a method 300 for selective preservation of materials related to discovery is shown. It is important to note that the method 300 may include additional or even fewer steps or processes in comparison to what is illustrated in FIG. 3. Moreover, the method 300 is not necessarily limited to the chronological order that is shown in FIG. 3. In describing the method 300, reference may be made to FIGS. 1 and 2, although it is understood that the method 300 may be practiced with any other suitable systems and components.

At step 305, a preservation notification based on a litigation event may be received at a computing device, and at step 310, the computing device may be placed in a preservation mode in response to the receipt of the preservation notification. At step 315, as part of the preservation mode, materials on the computing device that are to be preserved for discovery can be identified. Back-up copies of the identified materials can be automatically created to comply with preservation requirements related to the litigation event, as shown at step 320.

For example, the enterprise or organization responsible for operation of the administrator 105 may become involved in litigation or may face the possibility of litigation. As such, the enterprise may wish to take steps to preserve evidence that may be related to this litigation event. In particular, the enterprise may wish to preserve potentially-discoverable materials that are associated with the computing devices 115, such as those devices 115 that are used by associates of the enterprise.

To do so, the administrator 105 can send a preservation notification to the computing devices 115, which can be received through the interface 240. In one arrangement, the preservation notification can be delivered to computing devices 115 on a selective basis, or it can be a blanket delivery to all the computing devices 115 associated with the enterprise. In the case of a selective delivery, the administrator 105 can determine which computing devices 115 are to receive the preservation notification based on one or more factors. For example, the administrator 105 can select those computing devices 105 used by associates who may be directly involved with a project that led to the litigation event. As another example, the computing devices 115 may be selected because the associates who use them belong to a particular group, division or subsidiary that may be exposed to the litigation event. If desired, the computing devices 115 may even be selected on an individual basis.

The preservation notification may include information that can assist the recipient computing devices 115 for the preservation of materials. As an example, the preservation notification can identify which materials may need to be preserved, which applications 205 or other programs on the computing device 115 may be affected, or when the process of preserving materials should begin and the duration of such a process. Other exemplary forms of information that may be part of the preservation notification include the identity of the opposing party in the litigation event, the circumstances around which the litigation event revolves, or the destination for the materials to be preserved, such as the remote storage 120.

Once the preservation notification is received, the computing device 115 may enter a preservation mode. This process can be carried out by the preservation engine 235, working with the preservation application 210. There are numerous examples of steps than can be taken during the preservation mode. For example, materials that should be preserved can be identified as part of this process. To accomplish this task, applications 205 or other software programs that may be responsible for generating, receiving or processing materials that may need to be preserved can be identified and their respective storage spaces can be analyzed. This analysis can include searching the stored materials for certain terms or phrases or other metadata that may be related to the litigation event. For example, the name of the opposing party (or a portion thereof) may be a key term or phrase, and any stored materials (e.g., electronic documents) that reference this name can be flagged for possible preservation. Other search terms/phrases may include project names, the identities of individuals or virtually anything that may be related to the litigation event. In addition, the user of the computing device 115 may be made aware of the initiation of the preservation mode. For example, the user may be provided with instructions or other guidance to ensure compliance or may be directed to another source (e.g., a link) to obtain such information.

As noted above, certain applications 205 or other programs of the computing device 115 may be deemed relevant towards the preservation of materials during the preservation mode. In one arrangement, steps can be taken to ensure that only applications 205 on the computing device 115 that are relevant to the enterprise may be affected by the preservation mode. That is, the analysis and preservation techniques described herein may only apply to enterprise materials and not data that personally belongs to or is at least controlled by the user on a personal basis. For example, in some cases, the computing device 115 may include conventional applications and secure applications. Because an enterprise may be responsible for directing the installation of these secure applications, focusing only on secure applications for the preservation mode may limit the chances that applications or other programs that are related to the user's personal life will be affected. In fact, if a secure workspace or container has been generated on the computing device 115, the analysis of these applications 205 and other programs may be restricted to only those that are part of the secure workspace, or at least to those that have been installed under the direction of the enterprise. Additionally, the number and type of secure applications or programs that may be affected may be limited to those that are involved in the production of materials that may need to be preserved.

In one arrangement, it can be determined prior to the initiation of a preservation mode whether an application 205 is one that may be affected by a preservation mode in the future, such as when the application 205 is created, modified to be a secure application, or installed. In this case, the memory 230 may be compartmentalized to set aside space for storage of data that is created by these applications 205. By doing so, only certain sections of the memory 230 may need to be scanned for the preservation mode. In another arrangement, the data from these applications 205 can be tagged when stored or placed in the memory 230, either in addition to or irrespective of the memory 230 being compartmentalized. In either example, the amount of material or storage space that may need to be analyzed can be reduced, thereby resulting in a more efficient preservation mode.

As described above, the preservation mode can be configured such that only those applications 205 or other programs that are related to the enterprise may be affected by the preservation mode. As also previously noted, some (if not all) of the applications 205 associated with the enterprise may be secure applications. When these secure applications are created, the secure applications can be configured to register with the operating system 215, a secure framework or some other component, which can be used to facilitate the placement of the secure applications in a preservation mode. For example, the initial preservation notification can be received by the preservation application 210, and the preservation application 210 can determine which applications 205 are to be put in the preservation mode. The affected applications 205 can be notified through the operating system 215 (or other component), and these applications 205 can assist in the preservation of potentially discoverable materials. For example, the applications 205 can be configured to search for relevant materials that they have generated and stored or to permit another application 205 or module or component to do so, such as the preservation application 210 and/or the preservation engine 235.

Once any materials have been identified as warranting preservation, back-up copies of these materials can be automatically created, and these copies can be moved to storage. For example, the secure applications 205 can be configured to create back-up copies of the materials flagged during the preservation mode or to let some other component or module do so, such as the preservation application 210 and/or the preservation engine 235. The secure applications 205 can also be configured to enable the transfer of these copies to an appropriate storage unit. For example, the secure applications 205 can work with the preservation application 210 and the preservation engine 235 to cause the identified materials to be moved to storage. In one example, the interface 240 can direct these materials to the remote storage 120, although the storage unit can be part of the computing device 115, the administrator 105 or any other location. In any event, the storage unit can be any memory that can provide a third-party with access to these materials, should a discovery order from the litigation event dictate such circumstances.

As another part of the preservation mode, action can be taken to prevent the deletion of materials that may need to be preserved for discovery purposes. For example, the affected secure applications 205 may be configured to prevent the deletion of any materials that have been identified as being necessary to preserve. As another example, the secure applications 205 can be configured to suspend the deletion of any materials that are generated by the affected applications 205, at least until the initial analysis is completed. In fact, the computing device 115 can be configured to prevent the deletion of any potentially discoverable materials, if such a setting is desired or warranted. In one arrangement, the prevention of the deletion of such materials may be based on a process similar to identifying materials to be preserved, which was described above. For example, certain key words or phrases can be identified as relating to materials that should not be deleted, and if these words or phrases are contained in an analyzed document, the document may not be permitted to be deleted. In either arrangement, the blocking of delete actions can be put in place upon the receipt of the preservation notification.

In another embodiment, prior to being moved to storage, the identified materials may be encrypted to ensure their integrity during storage. For example, when the back-up copies are created, the encryption engine 245 can encrypt these materials prior to them being moved to storage. Any authorized party may be given access to keys or other information that can enable it to retrieve the encrypted data at a later time.

Referring once gain to the method 300 of FIG. 3, at decision block 325, it can be determined whether new materials on the computing device have been detected. If so, at decision block 330, it can be determined whether the new materials are to be preserved for discovery. If so, back-up copies of the new materials can be automatically and selectively created. If new materials are either not detected or not to be preserved, the flow of the method 300 can resume at decision block 325.

In particular, when the preservation mode is invoked, the computing device 115 may take steps to account both for the preservation of materials that have already been created and those that will be in the future. For example, the affected secure applications 205 may be configured to identify any new materials that may need to be preserved, such as when a new document is generated or a new message is received. These materials can be analyzed in a fashion similar to how the pre-existing materials were, and copies can be created and stored where appropriate. These new materials may also be encrypted and their deletion may be blocked, similar to that described above.

In one arrangement, once there is no longer a need to preserve materials related to the litigation event, the administrator 105 can send a termination notification to the affected computing devices 115. When received at an affected computing device 115, the applications 205 may discontinue their analysis and reproduction of new materials and can return to their conventional processing of such materials. Also, if desired, any materials that were preserved may be deleted, including those stored at the remote storage 120 or any other relevant memory unit.

Although this description presents the use of secure applications and secure workspaces, it must be understood that the principles presented herein are not so limited. For example, any suitable application or program on the computing device 115 may be configured to permit an analysis of any materials related to those applications or programs and to move any relevant materials to a secure storage facility for the preservation of such materials. In other words, the analysis of materials may not necessarily be limited to only those materials or applications and programs that are related to the enterprise or organization that is involved in the litigation event.

There is also an alternative process for analyzing materials of the computing device 115 for discovery purposes and creating back-up copies for storage where appropriate. Specifically, the computing devices 115 may be configured to perform a back-up procedure in which mass quantities of data from the computing device 115 are copied and stored remotely. This process may be particularly relevant to an enterprise that wishes to ensure its data is backed up to a secure location. In this case, if a preservation notification is received, an analysis of the data that is backed-up can be performed with a focus on identifying materials that may be related to the litigation event. If such materials are identified, back-up copies can be made and moved to a pre-designated storage unit. This storage unit may be part of the original remote storage unit, or it can be a storage unit at a different location. Like the description above, these materials may be encrypted to protect their integrity. To reduce traffic and to keep the system operating efficiently, the back-up procedures can be staggered based on certain groups of users. Moreover, the periodicity of the mass back-up procedures can be made more frequent for users who have been identified as being part of a group that may be required to preserve materials for discovery purposes. As such, the preservation of materials can be implemented into a pre-existing back-up procedure to improve operating efficiencies.

While various embodiments have been described above, it should be understood that they have been presented by way of example only, and not limitation. It will be understood by those skilled in the relevant art(s) that various changes in form and details may be made therein without departing from the spirit and scope of the subject matter as defined in the appended claims. Accordingly, the breadth and scope of the present description should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method for selective preservation of materials related to discovery, comprising:
receiving at a computing device a preservation notification based on a litigation event against an enterprise that warrants preservation of related documents;
in response to the receipt of the preservation notification, placing the computing device in a preservation mode;
as part of the preservation mode, identifying materials from at least enterprise materials on the computing device that are to be preserved for discovery, wherein the computing device is a personal computing device of an associate of the enterprise; and
automatically creating back-up copies of the identified materials to comply with preservation requirements related to the litigation event.

2. The method according to claim 1, further comprising:
detecting the creation or receipt of new enterprise materials on the computing device;
determining whether the new enterprise materials on the computing device should be preserved for discovery; and
selectively and automatically creating back-up copies of the new enterprise materials based on the determination of whether the new enterprise materials should be preserved for discovery.

3. The method according to claim 1, wherein automatically creating back-up copies of the identified materials includes transferring the back-up copies to a memory that is remote from the computing device.

4. The method according to claim 1, wherein the enterprise materials are associated with a workspace container that is part of the computing device.

5. The method according to claim 1, wherein the enterprise materials are only associated with secure applications that are installed on the computing device.

6. The method according to claim 1, further comprising preventing the deletion of the identified materials as part of the preservation mode.

7. The method according to claim 1, further comprising encrypting at least a portion of the back-up copies of the identified materials.

8. The method according to claim 1, wherein identifying materials from at least enterprise materials on the computing device comprises analyzing electronic documents for predetermined key words or phrases.

9. A method for selective preservation of materials related to discovery, comprising:
receiving at a computing device a preservation notification based on a litigation event against an enterprise that warrants preservation of related documents, wherein the computing device is a managed device associated with the enterprise;
in response to the receipt of the preservation notification, placing the computing device in a preservation mode;
as part of the preservation mode, identifying materials from only enterprise materials on the computing device for preservation for discovery; and
automatically creating back-up copies of the identified materials to comply with preservation requirements related to the litigation event.

10. The method according to claim 9, wherein the enterprise materials are limited to materials associated with secure applications that have been installed on the computing device.

11. The method according to claim 10, wherein at least one of the secure application is a secure email application.

12. The method according to claim 9, further comprising:
transferring the back-up copies to a remote storage; and
as part of this transfer, encrypting the back-up copies.

13. The method according to claim 9, wherein the preservation notification identifies which materials are required to be preserved, which applications or programs installed on the computing device are affected, when the preservation mode should be entered, the identity of the opposing party in the litigation event or the destination for the back-up copies.

14. A computing device that is associated with an enterprise, comprising:
an interface that is configured to receive a preservation notification based on a litigation event against the enterprise, wherein the litigation event warrants preservation of related documents and the computing device is a managed device with respect to the enterprise; and
a preservation engine, wherein the preservation engine is configured to—in response to the preservation notification:
place the computing device in a preservation mode;
while in the preservation mode, identify materials on the computing device that are to be preserved for discovery; and
automatically create back-up copies of the identified materials to comply with preservation requirements related to the litigation event.

15. The computing device according to claim 14, further comprising an encryption engine that is configured to encrypt the automatically created back-up copies.

16. The computing device according to claim 14, wherein the preservation engine is further configured to identify the materials to be preserved by initiating an analysis of electronic documents for key words or phrases.

17. The computing device according to claim 14, wherein the interface is further configured to transfer the back-up copies to a remote storage location.

18. The computing device according to claim 14, wherein one or more parties other than the enterprise are given access to the remote storage location.

19. The computing device according to claim 14, wherein the identified materials are limited to materials associated with secure applications that have been installed on the computing device, and at least one of the secure applications is a secure email application.

20. The computing device according to claim 14, wherein the preservation engine is further configured to:
detect the presence of new enterprise materials on the computing device; and
selectively and automatically creating back-up copies of the new enterprise materials based on whether the new enterprise materials should be preserved for discovery.
